(19) United States
(12) Patent Application Publication
(10) Pub. No.: US 2016/0272012 A1
(43) Pub. Date: Sep. 22, 2016

(54) TIRE WITH TREAD HAVING BRIDGED AREAS WITH SPLIT CONTACT FACES WITHIN A LONGITUDINAL GROOVE

(71) Applicants: David Scott Morgan, Greenville, SC (US); Sadi Kose, Greer, SC (US)

(72) Inventors: David Scott Morgan, Greenville, SC (US); Sadi Kose, Greer, SC (US)

(73) Assignees: COMPAGNIE GENERALE DES ETABLISSEMENTS MICHELIN, Clermont-Ferrand (FR); MICHELIN RECHERCHE ET TECHNIQUE S.A., Granges-Paccot (CH)

(21) Appl. No.: 15/169,611

(22) Filed: May 31, 2016

Related U.S. Application Data
(63) Continuation-in-part of application No. 14/114,726, filed on Oct. 29, 2013.

(51) Int. Cl. B60C 11/13; B29D 30/52; B60C 9/18; B60C 11/03; B60C 9/02

(52) U.S. Cl. CPC B60C 11/1307; B60C 11/0309; B60C 11/1376; B60C 9/02; B60C 9/18; B29D 30/52; B60C 2011/0353; B60C 2011/0365; B60C 2011/1338

(57) ABSTRACT

The present invention includes a tire tread for a tire having laterally and circumferentially extending grooves that define tread blocks. The tread includes one or more split bridges extending within one groove of said grooves and extending from one of a pair of opposing sides. Each of the one or more split bridges has a length spanning the groove width except for a narrow gap, the length being formed by one or more projections extending from one of the opposing sides and towards the other of the opposing sides. One projection of the one or more projections extends from one side of the opposing sides of the one groove, where each of the one or more split bridges is spaced a predetermined distance from a bottom surface of the groove to provide a void between the split bridge and the bottom surface.

### CROSS-REFERENCE TO RELATED APPLICATIONS

This application claims priority to, and the benefit of, U.S. patent application Ser. No. 14/114,726, filed Oct. 29, 2013 with the U.S. Patent Office, and which is a National Stage Entry of International Patent Application No. PCT/US2011/34431, filed Apr. 29, 2011 with the U.S. Patent Office acting as a Receiving Office, each of which are also incorporated herein by reference.

### BACKGROUND OF THE INVENTION

1. Field of the Invention

This invention relates generally to tires having treads that have a configuration and/or properties for maintaining hydroplaning performance and improving rolling resistance, and, more specifically, to a tire that has a tread with bridged areas found in its lateral grooves that are configured to maintain hydroplaning performance and snow traction while also improving rolling resistance.

2. Description of the Related Art

The reduction of the consumption of energy by vehicles as they travel has become an important goal due to the increase in fuel prices. In many cases, this need affects the development of tires, requiring them to take into account the problem of rolling resistance. Accordingly, tire designers need to design tires having lower rolling resistance. Rolling resistance is an indicator of the energy loss of a tire due to rolling, which in turn results in the generation of heat. This loss heat from the tire is a significant contributor to the total energy loss by the vehicle during its movement. By reducing the rolling resistance of the tire, less energy is consumed by the vehicle for a given journey, as a result, the user spends less money to travel.

In particular, it is known that the rolling resistance of a tire is directly related to energy losses in the tire, which in turn, is dependent on the characteristics of the hysteresis of the mixtures of rubber employed in the tire, especially those of the tread of the tire. The tire's energy loss is also dependent on the deformations that the tread rubber undergoes as the tire rolls into, through and out of the contact patch as well as the deformations of the tire components outside of the tread. For example, if one considers what occurs during the rolling of the tire, that in the zone of contact or rolling patch, the tread is compressed in a direction that is perpendicular to the ground (radial direction of the tire) where the contact occurs. This compressive solicitation, driven by the weight of the vehicle as well as the tread's reaction to vertical asperities in the road surface, consumes energy through shear deformation, driven by the Poisson effect. Also, shearing forces and resulting energy losses are exerted on the tread as it deforms to meet the ground in the circumferential and lateral directions of the tire, due to the curved structure of the tire conforming to the road surface. Finally, under pure rolling in the contact patch, shear forces in the rolling direction are naturally developed in the tread between the belts and the adherent contact with the ground. These shear forces under pure rolling also consume energy.

Consequently, one way to decrease these energy loss effects and the resulting increase in rolling resistance associated with them, is to add features that decrease the deformation of the tread as the tire rolls into, and out of the contact patch. Yet, another possibility for reducing these energy losses concerns the way in which the tread is equipped with incisions or notches to reduce the strains placed on the tread as it rolls into and out of the contact patch. For example, it is known in European Patent No. EP0787601 that it is possible to achieve this goal by configuring the tread with a plurality of incisions that are oriented laterally that have a specified spacing according to the geometrical dimensions of the tire. While this technique works for lowering rolling resistance and can be effective for snow traction, it may not have a significant impact on hydroplaning resistance.

Accordingly, it is desirable to find a construction for the tread of a tire that is able to lower rolling resistance by limiting compression and shear losses, while at the same time maintain the hydroplaning performance of the tire. In addition, it would be advantageous if the solution maintained snow traction performance as well.

### SUMMARY OF THE INVENTION

The present invention comprises tire treads, and methods of molding and demolding said tire treads. In particular embodiments, the invention comprises a tread for a tire having laterally and circumferentially extending grooves that define tread blocks. The tread includes one or more split bridges extending within one groove of said grooves and extending from one of a pair of opposing sides defining a groove width of the one groove. Each of the one or more split bridges has a length spanning the groove width except for a narrow gap arranged between the opposing sides defining the groove width, the length being formed by one or more projections extending from one of the opposing sides of the one groove and towards the other of the opposing sides. One projection of the one or more projections extends from one side of the opposing sides of the one groove, where each of the one or more split bridges is spaced a predetermined distance from a bottom surface of the groove to provide a void between the split bridge and the bottom surface.

In other embodiments, the invention comprises a method of demolding a tire tread. The method includes providing a mold having a molding cavity configured to mold a tire tread having laterally and circumferentially extending grooves that define tread blocks and one or more split bridges extending within one groove of said grooves and extending from one of a pair of opposing sides defining a groove width of the one groove, each of the one or more split bridges having a length spanning the groove width except for a narrow gap arranged between the opposing sides defining the groove width, the length being formed by one or more projections extending from one of the opposing sides of the one groove and towards the other of the opposing sides, where one projection of the one or more projections extends from one side of the opposing sides of the one groove, where each of the one or more split bridges is spaced a predetermined distance from a bottom surface of the groove to provide a void between the split bridge and the bottom surface. The method further includes molding polymeric material inserted into the molding cavity to form a molded tread and demolding the molded tread from the mold, where a molding member for forming the split bridge of the one or more split bridges arranged between the split bridge and the bottom surface of the one groove during the step of molding is pulled through the split bridge by deforming the one projection.

The foregoing and other objects, features and advantages of the invention will be apparent from the following more detailed descriptions of particular embodiments of the invention, as illustrated in the accompanying drawing wherein like reference numbers represent like parts of the invention.

### BRIEF DESCRIPTION OF THE DRAWINGS

FIG. 1 is a fragmentary perspective view of a lateral groove of a tire that has split bridges therein according to a first embodiment of the present invention where the height of the split bridges in the radial direction of the tire is relatively large;

FIG. 2 is a fragmentary perspective view of a lateral groove of a tire that has split bridges therein according to a second embodiment of the present invention where the thickness of the split bridge in the radial direction of the tire is relatively small and a large radius is present on the edges of the bridge to aid in water flow through the groove and demolding of the mold blade that forms the bridge and groove;

FIG. 3 is a fragmentary perspective view of a lateral groove of a tire that has split bridges therein according to a third embodiment of the present invention where two differently sized and configured bridges are present;

FIG. 4 is a mold blade that forms the groove and split bridges shown in FIG. 3;

FIG. 5 is a mold blade that forms yet another configuration of split bridges that have a substantially rectangular profile;

FIG. 6 is a mold blade that forms another configuration of split bridges that have a substantially ovular profile;

FIG. 7 is sectional view of a shoulder tread block and an intermediate tread block taken along a lateral plane of the tire showing dimensions of the split bridges made by the mold blades shown in FIGS. 4 and 6;

FIG. 8 is a top view of a tread showing split bridges that extend from only side of a lateral groove;

FIG. 9 is a top view illustrating that the gap or incision in the split bridge may be straight;

FIG. 10 is a top view of another version of the split bridge where the gap or incision that splits the bridge has a saw tooth or zig zag profile;

FIG. 11 is a sectional view along a lateral plane of a tread showing multiple split bridges that are positioned at different radial heights of the tire;

FIG. 12 is a top view of a tire tread where the split bridges are not aligned laterally from one lateral groove to the next but alternate laterally instead;

FIG. 13 is a sectional view along a lateral plane of a tread showing a split bridge within the prior art;

FIG. 14 is a sectional view along a lateral plane of a tread showing a split bridge within the prior art;

FIG. 15 is a sectional view along a lateral plane of a tread showing a split bridge within the prior art;

FIG. 16 is a sectional view along a lateral plane of a tread showing a split bridge within the prior art;

FIG. 17 is a sectional view along a lateral plane of a tread showing a split bridge within the prior art;

FIG. 18 is a sectional view along a lateral plane of a tread showing a split bridge within the prior art; and,

FIG. 19 is a sectional view along a lateral plane of a tread showing a split bridge within the prior art.

### DEFINITIONS

By groove, it is meant any channel in the tread of a tire that has two opposing sidewalls that lead from the top surfaces of the tread and that are spaced apart by at least 1.5 mm, i.e. that the average distance separating the sidewalls between the top opening of the channel and the bottom thereof is on average 1.5 mm or more.

By a sipe, it is meant any incision that is less than 1.5 mm and has sidewalls that come into contact from time to time as the tread block or rib that contains the incision rolls into and out of the contact patch of the tire as the tire rolls on the ground.

The circumferential direction, C, is the direction of the tire along which it rolls or rotates and that is perpendicular to the axis of rotation of the tire.

The lateral direction, L, is the direction of the tire along the width of its tread that is substantially parallel to the axis of rotation of the tire. However, by lateral groove, it is meant any groove whose general direction or sweep axis forms an angle with the purely lateral direction that is less 45 degrees.

The radial direction, R, is the direction of a tire as viewed from its side that is parallel to the radial direction of the generally annular shape of the tire and is perpendicular to the lateral direction thereof.

### DETAILED DESCRIPTION OF PARTICULAR EMBODIMENTS

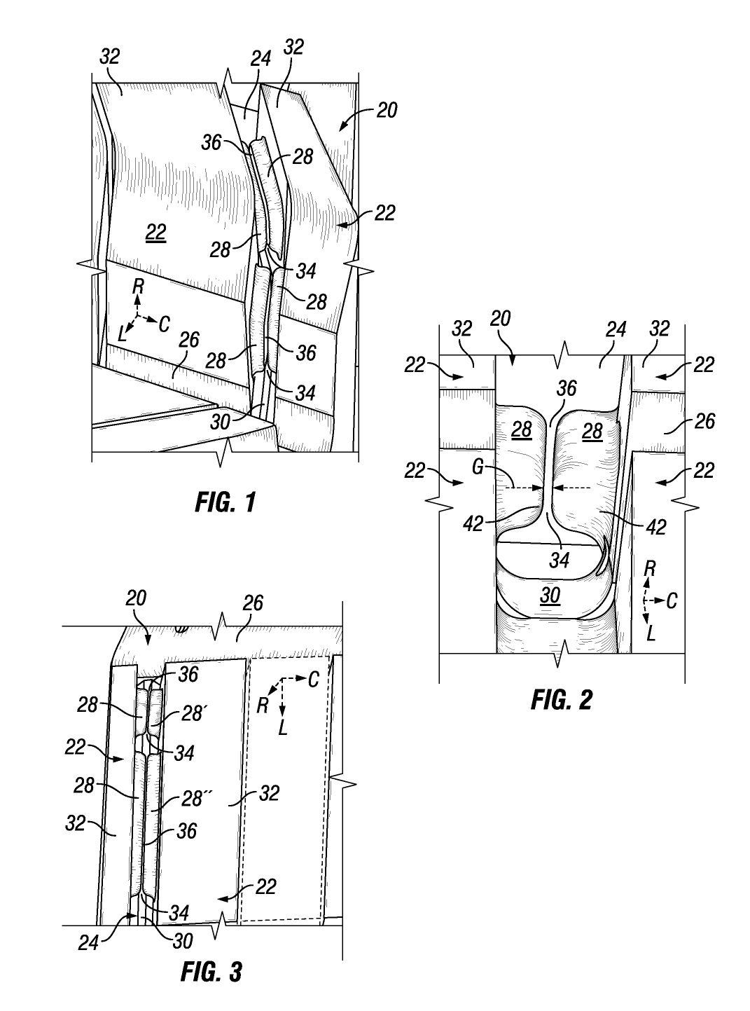

Looking at FIGS. 1-3, a tire 20 having lateral L, circumferential C and radial R directions with tread blocks 22 that are defined by lateral and circumferential grooves 24, 26 is shown. These figures also show different versions of bridges 28 found within the lateral grooves 24 that have a split configuration and that are spaced a predetermined distance from the bottom surface 30 of a lateral groove 24 and from the top surface 32 of a tread. By introducing rubber or bridging in the lateral grooves 24, the evacuation and absorption of water is usually limited, causing the resistance of the tire to hydroplaning to degrade, which means that the tire will hydroplane at lower speeds. However, with the present invention, there is an open channel 34 found below the bridging, which allows for water to pass through the lateral groove throughout the life of the tire. Hence, hydroplaning performance is not deleteriously affected.

In like fashion, bridging usually involves the use of a solid section of rubber that spans from tread block to the next in order to limit tread block deformation due to compression and shear forces as the tread block rolls into and out of contact with the ground. However, this type of bridging does not allow the tread block to effectively bend as it enters or exits the contact patch, and therefore results in higher energy losses. Consequently, the present invention includes a split configuration of the bridge so that one tread block is free to move away from another tread block, as the tread block rolls into and out of contact with the ground, thus deformation due to bending can be minimized. This, in turn, allows the rolling resistance of the tread to be lowered. The gap 36 created by this split configuration is sufficiently small so that it can be closed quickly, making the bridges 28 contact each other so that the tread block 22 will not deform significantly due to compressive and shear forces when it is in the contact patch. This also allows the rolling resistance of the tread to be lowered. Thus, the placement and configuration of the split bridges 28 relative to the lateral grooves 24 and the tread blocks 22 impacts the rolling resistance and wet performances of the tire.

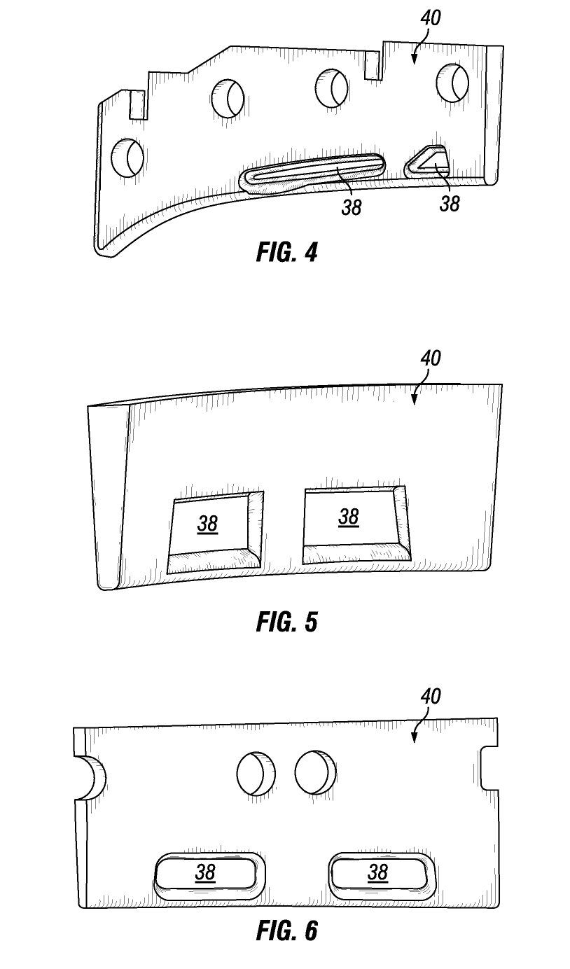

Looking at FIGS. 1 and 2, it can be seen that the shape of the bridges 28 can vary. For example as shown in FIG. 1, the bridges 28 can be separated into two or more units that have a relatively deep cross-section in the radial direction R of the tire. On the other hand as shown in FIG. 2, the bridge 28 can be a single thin and long unit. Yet a third embodiment is shown in FIG. 3, where a relatively small sized bridge 28′ is adjacent to a larger sized bridge 28″. Focusing now FIGS. 4, 5 and 6, the shapes and sizes of different bridges 28 can be understood by looking at the cavities 38 of mold blades 40 that form them, realizing that the bridges 28 and grooves 24 of the tread will be complimentary shaped and be in the form of a negative image as compared to the geometry of the mold blade 40. Hence, the cross-sectional shape of the bridges 28 could have any desired shape that suits a particular application, such as triangular (see FIG. 4), rectangular (see FIG. 5), or ovular (see FIG. 6). These mold blades 40 may be manufactured by means commonly known in the art.

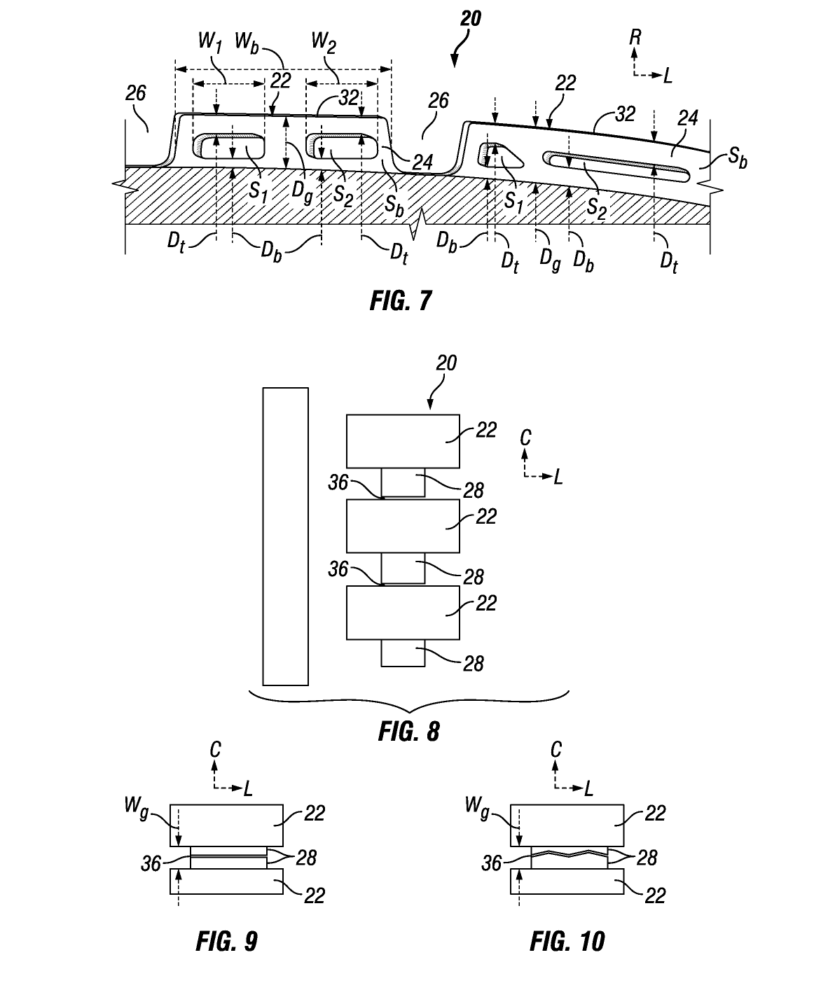

Looking now at FIG. 7, it shows a third of the width of a tire tread along the lateral direction L of the tire 20, starting at one shoulder, which uses an embodiment of the present invention. In particular, the tread is formed using the mold blade 40 depicted by FIG. 4 in the shoulder area while the mold blade 40 depicted in FIG. 6 creates the bridges 28 found in the adjacent or intermediate tread block 22. Looking closely at this figure, some dimensions that can be used by a designer to achieve the unexpected and critical results of the present invention can be seen. The distance from the top of the tread 32 to the top of a bridge, Dₜ, is preferably in the range of between 0.5 to 2.5 mm while the distance from the bottom 30 of a lateral groove to the bottom of a bridge, D_{b}, should preferably be in the range of 0.9 to 4.0 mm. In cases where there are blends, radii or chamfers that transition from the lateral surface of a lateral groove, dimensions Dₜ and D_{b} exclude such features. In the case of a fluted wine bottle shape, the D_{b} measurement is taken at the inflection of the curve where the positive and negative radii join.

Along the lateral surface of a tread block, the ratio of the aggregate widths, Wₜₒₜ, of the bridges found along this surface to the width of this lateral surface, W_{b}, of the tread block should be in the range of 30 to 80% for the most effective reductions in energy loss. For example, Wₜₒₜ would be the sum of W₁ and W₂ where two bridges are present along the lateral surface of a tread block and W₁ and W₂ are the widths of the two bridges. For this particular embodiment, the depth, D_{g}, of the lateral grooves can range from 5.5 to 10.0 mm. Alternatively, the ratio of the summation of the lateral surface areas, Sₜₒₜ, of the bridges to the surface area, S_{b}, of the lateral surface of a tread block assuming no bridges are present should be in the range of 10 to 40%. For example, Sₜₒₜ would be the sum of S₁ and S₂ where two bridges are present along the lateral surface of a tread block and S₁ and S₂ are the surface areas respectively of these bridges.

In many cases, the distance or gap, G, between each split bridge (best seen in FIG. 2) is the same and is preferably 0.5 mm or less so that the split bridges contact each other quickly as the tread blocks along which they are found roll into and out of the contact patch. For the tire discussed later, the gap was in fact 0.15 to 0.2 mm. While the bridges 28 are split half way across the width of the lateral groove 24, it is contemplated that the split could occur anywhere along the width of the lateral groove 24. At an extreme, the bridge 28 could extend only from one side of the groove 24 to the opposing lateral surface of an adjacent tread block 22, as best seen in FIG. 8. Also, the gap 36 does not need to be straight (see FIG. 9) but could be have a zig zag configuration (see FIG. 10) or some other arbitrary shape either in the L-C plane or C-R plane. The advantage of having an interlocking shape such as a zig zag shape is that it helps the bridges 28 prevent deformation of the block 22 both circumferentially C as well as laterally L, which helps to decrease rolling resistance even more. Also, the gap 36 itself may vary in width. The surfaces of the bridges near the gap may be smooth, textured or some combination thereof. The width, W_{g}, of the lateral groove 24 may be 1.5 to 10 mm for any of the embodiments discussed herein.

Alternatively, the design of these split bridges can be put into dimensionless parameters so that the present invention can be applied to tires having different sizes. For example, the ratio of Dₜ/D_{g}, which is the ratio of the distance from the top of the tread to the top of the bridge to the depth of the lateral groove, should be in the range of 10 to 40%. Similarly, the ratio of D_{b}/D_{g}, which is the ratio of the distance from the bottom of the lateral groove to the bottom of the bridge, should be in the range of 15 to 50%. Similarly as stated previously, along the lateral surface of a tread block, the ratio of the aggregate widths, Wₜₒₜ, of the bridges found along this surface to the width of this lateral surface, W_{b}, of the tread block should be in the range of 30 to 80%.

Looking back at FIG. 2, a preferred cross-sectional shape as viewed in the lateral direction L of the tire 20 is shown. This shape on the inferior surface of the split bridge can be compared to that of a fluted wine bottle where radii 42 are used where the bridges 28 intersect with the lateral surfaces of the tread blocks 22 and where the bridges terminate at their free ends. This helps to reduce stress concentrations as the bridges contact each other, helping to keep them intact during cyclic use. In addition, these radii are three dimensional in nature, which allows them to funnel water into the lower passage 34 found below the bridge 28. This promotes laminar flow of water through this channel, which contributes to maintaining the hydroplaning resistance of the tire. Also, these radii aid in demolding the mold blade that forms the groove and bridges. In some cases, the size of the radius used is almost half the thickness of the bridge.

In order to optimally reduce rolling resistance, these split bridges that are configured per the above guidelines, should be found on the lateral surfaces of every tread block of the tire across the entire width of the tire in its lateral direction. This does not have to be case however if other performances are affected deleteriously by such a universal use of these bridges. Thus, applications where only a portion of the lateral surfaces of tread blocks have such bridges are also contemplated.

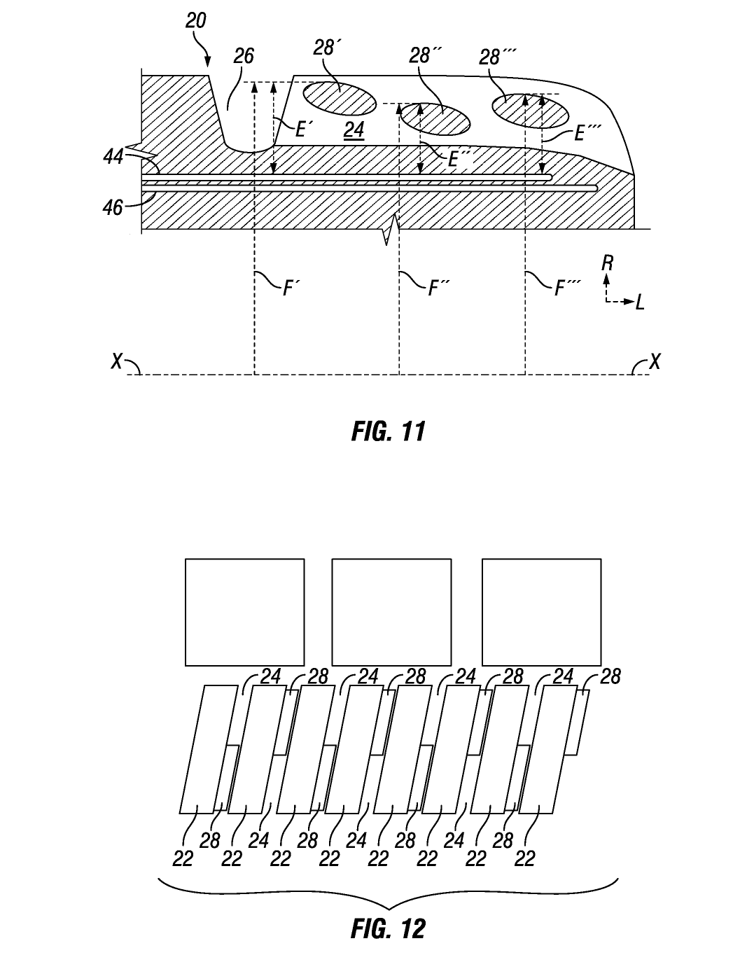

Turning now to FIG. 11, another application of the present invention is shown where a tire 20 that has at least two belts 44, 46 found beneath the tread is used in conjunction with bridges 28 that are configured as previously described. In addition, such a tire will usually have circumferentially oriented grooves 26 or grooves oriented at an oblique angle greater than 45 degrees to the lateral direction L of the tire for the absorption of water and/or snow as the tire rolls. This tire also has lateral grooves 24 that define lateral surfaces on which the split bridges 28 are found. The tire defines a dimension E, which is the distance from the top portion of the top belt 44 to the average position of the top surface of the split bridges 28 in the radial direction R of the tire, and another dimension F, which is the distance from the axis of rotation X-X of the tire to the average position of the top surface of the split bridges in the radial direction of the tire. The inventors have found that it is preferred that the ratio of E/F be in the range of 1.5 to 4%. This is particularly applicable to a 225/50R17 sized tire where E/F is 2.1%, or put into actual dimensions, E is 6.8 mm and F is 322 mm.

Looking more closely at FIG. 11, there are three bridges 28′, 28″, 28′″ shown in a lateral cross-sectional view of the tire. Each is at a slightly different radial height with respect to the tire. Therefore, the E value and F value of each bridge (E′, E″, E′″ as well as F′, F″, F′″) would be averaged. The resulting values, Eₐᵥₑ and Rₐᵥₑ, would then be used to obtain the ratio Eₐᵥₑ/Rₐᵥₑ. Ideally, this ratio would fall into the range of 1.5 to 4%. It should also be noted that the configuration and position of the bridges found in one lateral groove does not necessarily need to be the same as the bridges found in an adjacent lateral groove. For example, looking at the tread such as that shown in FIG. 12, the bridges 28 can have a staggered position from one lateral groove 24 to the next. In other cases, the bridges will be aligned from one lateral groove to the next in the lateral direction as seen in FIG. 8.

As can be seen, these embodiments provide a way to add rubber volume to the lateral grooves of a tire only in places where it is most effective for reducing the rolling resistance of the tire. Thus, the benefit of maximum tread block compliance at the entrance and exit of contact, and the benefit of increasing tread block rigidity within the contact patch, both of which lower rolling resistance, are maximized while the penalty of having increased mass, which can lead to more hysteresis and higher rolling resistance, is minimized. Also, the positioning of the bridges allows for water movement within the lateral groove so that hydroplaning resistance is not decreased. As the tire wears, these bridges disappear at a time when the blocks are naturally more rigid and their presence is no longer needed. At this time, the lateral grooves are shallower and are now completely free of any obstructions, which allow the tire to maintains its hydroplaning resistance, while at the same time, no extra rubber is present, which also aids in reducing the rolling resistance of the tire.

Testing of a 225/50R17 sized tire that has split bridges found along the lateral surfaces of every tread block of the tire that are configured according to the guidelines given above, has revealed surprising and unexpected results. The tire exhibited a significant 2.6% reduction in tire rolling resistance. At the same time, the inventors of the present invention expected a statistically significant decrease in the speed at which hydroplaning occurred due to the volume of obstruction created by the additional rubber used to create these bridges. It was theorized that this would limit the flow of water in the lateral grooves, and by consequence, the absorption of water by the tire as it passes through puddles of water. Similarly, a reduction in snow traction was anticipated for similar reasons.

However, virtually identical hydroplaning results were achieved between a tire lacking the split bridges and a tire having the split bridges (hydroplaning speeds for the two configurations of tires were within 0.02 km/h of each other) using the following test procedure. The front wheels of a test vehicle having front wheel drive were then fitted with two tires—each having the same tread pattern. The test vehicle was driven through water having a controlled depth of 8 mm on an asphalt track at a speed of 50 kph. Preferably, this speed was maintained by using e.g., cruise control on the vehicle. Once the vehicle reached the validation area, the driver accelerated the vehicle as quickly as possible for 30-50 m (this distance is fixed as desired) to see if 10% slip could be generated between the speed of the drive wheels and the GPS speed of the vehicle. If 10% slip was achieved, this same test run was repeated three more times. If 10% slip was not achieved, then the test run was performed by adding 5 kph to the initial vehicle speed. This step was then repeated until 10% slip was achieved. Once the 10% slip was achieved, then another three runs at the same conditions as previously described was conducted. Usually, five total runs were made with the first and last runs being used for reference only. Data is then acquired from these runs and a statistically relevant calculation of the speed at which hydroplaning occurs, which corresponds to the vehicle speed at which 10% slip happens, is constructed. Using this data, a performance measurement result was created.

As previously stated, the speeds at which 10% slip occurred for a tire with the split bridges and a tire without the split bridges was virtually the same. Also, no statistically significant reduction in snow traction was observed. So, the apparent compromise between using bridging for improving rolling resistance versus detrimentally affecting hydroplaning resistance as well as snow traction has been broken.

It is appreciated that the split bridges discussed above, in any variation discussed or by assembling any combination of the features described in association with the split bridges discussed above, may instead or additionally be arranged in a longitudinal groove, where a longitudinal groove extends entirely, substantially, or primarily in a lengthwise direction of the tire tread (the direction defining the length of the tread), which is a circumferential direction when installed on a tire. By extending primarily in a longitudinal direction, the longitudinal groove may have a lateral vector component, but it is the longitudinal vector component of the overall path along which the longitudinal groove extends. Substantially is within a manufacturing tolerance of entirely extending in the longitudinal direction. It is noted that the longitudinal direction is perpendicular to the lateral direction (the direction defining the width of the tread). While split bridges described herein may be arranged in any longitudinal groove, in particular instances, the longitudinal grooves have widths from 2 mm to 12 mm, and more specifically from 3 mm to 9 mm, and depths from 6 mm to 13 mm, and more specifically from 7 mm to 11 mm. It is also noted that split bridges may be arranged in any longitudinal groove so to occupy, for any given longitudinal groove, 15% to 75%, or 25% to 67%, or any other desired percentage, of the total length of any one side of a longitudinal groove having a contact face (that is, the total length of one side of a longitudinal groove minus any and all voids arranged along the side of the groove along the length of the groove—such as, for example, lateral sipes and/or grooves intersecting the longitudinal groove). Additionally, it is appreciated that while any split bridge may occupy any desired percentage of the height (i.e., depth) of any such longitudinal groove, such as any discussed in association with any lateral groove above. Lastly, for any split bridge arranged in any longitudinal groove, while the split bridge may be arranged at any location along the height of the longitudinal groove, in particular instances, the distance from the top of the tread to the top of a bridge, which is referred to herein as Dₜ in certain figures, is in the range of between 0.5 to 2.5 mm while the distance from the bottom of a lateral groove to the bottom of a bridge, which is referred to herein as D_{b} in certain figures, is in the range of 0.9 to 5.0 mm.

Just as with the split bridges discussed above within lateral grooves, the split bridges in longitudinal grooves limit the Poisson effect of the surrounding tread during compressive loading by limiting the deflection of the surrounding tread by supporting the sides of the grooves or tread elements. This in turn reduces energy losses and rolling resistance. It has also appreciated that the arrangement of split bridges in longitudinal grooves does not sacrifice snow traction, and has actually been observed to increase snow traction in certain tires. In testing, two versions of a LT265/70R17 tire were tested under a snow spin traction test in accordance with ASTM F1805-12, where the friction coefficient was measured for each tire version over the course of three different days of testing. As a result, split bridges arranged in longitudinal grooves 1 and 4 of a 5-rib design in one version of the tire (resulting in a 54 spin rating) generated a 9 point spin rating advantage over the other version of the tire having no longitudinal split bridges (resulting in a 45 spin rating). In summary, the results showed a 20% improvement in snow traction (reduction in slip) for the tires having split bridges over the tires not including split bridges. With regard to the versions tested, in the one version, split bridges were designed to cover approximately 56% of the circumferential length of each of grooves 1 and 4 (the outermost grooves on opposing sides of the tread width). The tread depth of the tire was approximately 8.6 mm, and the height of the split bridge contact faces was approximately 3.2 mm. The Dₜ dimension from the surface of the tread was approximately 1.0 mm. The D_{b} dimension from the base of the groove was approximately 4.0 mm. The contact faces were approximately rectangular in shape. Individual areas of split bridge contact faces ranged from approximately 16 to 32 mm². In summary, all tires were molded using the same mold and formed of the same materials, the exception being that for the second version not having any split bridges, the molded split bridges were removed using a heated knife.

It is noted, however, that when arranging split bridges in longitudinal grooves, increased difficulties may arise without providing improvements to the design or configuration of such split bridges. For example, when using a mold such as a clam shell-type mold or any other type of mold that during demolding operations, the mold is pulled from the tread by relative translation between the mold and the tread primarily in a lateral direction of the tire tread in a direction toward the closest lateral side edge of the tread. Because of this lateral translation, at least one projection of a pair of projections forming a symmetric split bridge (where the bridge has the narrow gap located in the midpoint of the bridge length, whereby each of the projections is generally the same length) resists the demolding forces acting in the lateral direction by virtue of the lateral translation. This resistance is substantially reduced in the situation of a symmetrical split bridge, when only demolding in the direction of the tread thickness, e.g., in the radial direction. Therefore, when demolding tire treads by generating relative translation between the tread and the mold in a substantially lateral direction (with or without a radial component of translation), improvements to split bridges are herein described to reduce resistance to demolding operations. It is appreciated that demolding the tread from the mold by primarily lateral translation may form the only relative translation between the tire tread and the mold during demolding operations, or is may be the primary translation component, meaning, the demolding operation may also include some translation in an outward direction of the tread thickness (this direction being a radial direction when the tread is molded in an annular mold or with a tire), or in a normal direction to the outer, ground-engaging side in a flat tire tread mold).

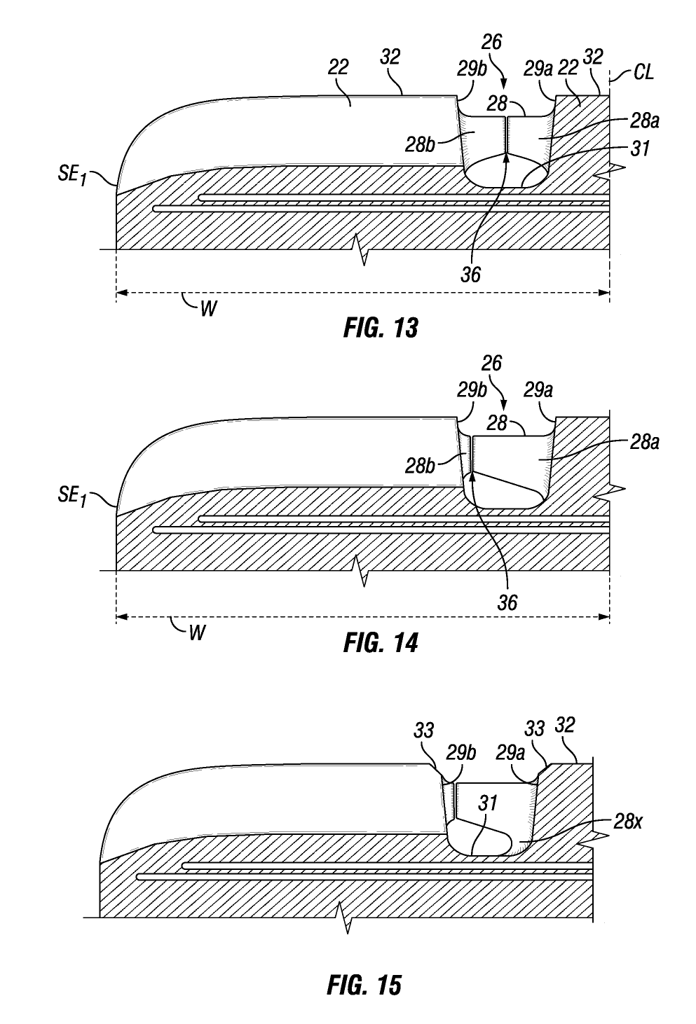

With reference to an exemplary embodiment in FIG. 13, one or more split bridges are arranged within at least one groove of a tire tread having laterally and circumferentially extending grooves that define tread blocks. In particular, FIG. 13 provides a tread having tread blocks 22 and a split bridge 28 extending within one longitudinal groove 26 and extending from one of a pair of opposing sides 29a, 29b, which define a width of the longitudinal groove 26. For the groove 26, the opposing sides 29a, 29b each include a longitudinal surface. The split bridges has a length spanning the groove width, whereby the length extends between the opposing sides 29a, 29b of the groove 26, except for a narrow gap 36 arranged between the opposing sides defining the groove width. In this embodiment, the narrow gap is arranged between terminal ends of the pair of projections. It is appreciated that the narrow gap 36 may form any variation of any gap described elsewhere herein, and which may form any desired sipe and have a width of 0.5 mm or less or 0.4 mm or less, such that the gap does not close except during tire use, namely under loading in the contact patch, which is the area along the tread where the tire tread contacts a surface upon which the tire is operating. The narrow gap 36 is spaced apart from a midpoint of the split bridge length, the length being formed by a pair of projections each extending from one of the opposing sides 29a, 29b of the groove 26 and towards the other of the opposing sides. Further, the split bridge 28 is spaced a predetermined distance from a bottom surface 31 of the groove to provide a void between the split bridge and the bottom surface. In this embodiment, the split bridge is also is spaced apart from the top surface of the tread, but this is optional. These predetermined spacings from the groove bottom surface and the tread top surface may form any spacing and any combination of spacings described elsewhere herein. Finally, pair of projections 28a, 28b forming the split bridge 28 are of substantially equal length, where the narrow gap 36 is arranged at a midpoint of the split bridge length. In this embodiment, due to the projections 28a, 28b being of substantially equal length and due to the narrow gap 36 being located at the split bridge midpoint, projection 28b is located closest to the tread side edge SE1 and therefore resists demolding when demolding includes relative lateral translation between the tread and mold in the direction of the tread side edge SE1.

One manner for resolving this demolding issue, the narrow gap is moved from the midpoint. With reference to an exemplary embodiment in FIG. 14, the split bridge of the embodiment of FIG. 13 is modified such that the narrow gap is arranged closer to the opposing groove side 29b, which is the lateral direction for demolding. By doing so, the length of one projection 28a is greater than 50% of the split bridge length or 50% of the groove width. In this variation, the second projection 28b extends from the other groove side 29b by a length less than 50% of the split bridge length or 50% of the groove width. In other embodiments, the length of the one projection 28a is equal to or greater than 67% of the split bridge length or 67% of the groove width, while the length of the second projection is equal to or less than 33% of the split bridge length or 33% of the groove width. In certain instances, such as the one shown, the groove, at the location of the split bridge, is located closer to the first side edge SE1 than the second side edge along the tread width, and the other side 29b of the pair of sides of the groove 26 is located closer to the first side edge SE1 of the tread width than the one side 29a of the opposing sides.

It is appreciated that in any embodiment discussed previously or hereafter, for a split bridge formed of one or more projections, any one of the projections optionally extends from the groove bottom surface and from the one of the pair of opposing sides of the one groove such that the width of the one groove below the one or more projections is narrowed. In doing so, the projection is strengthened at its base to reduce the formation of cracks as the projection deflects during demolding operations to release a mold member from the void arranged between the bridge and the groove bottom surface. For example, with reference to an exemplary embodiment shown in FIG. 15, for one of a pair of opposing projections 28a, 28b forming split bridge 28, projection 28a extends from the groove bottom surface 31 and from the one side 29a of the pair of opposing sides of the groove 26 such that the width of the groove below the one or more projections is narrowed.

It is appreciated that in any embodiment discussed previously or hereafter, at a junction between the tread top surface and the groove at one or both of each opposing sides of the groove, a chamfer or fillet may be optionally arranged between the top surface and the groove so to provide additional clearance for the mold in demolding when such demolding includes any relative lateral translation between the tread and the mold. For example, with reference to an exemplary embodiment in FIG. 15, a chamfer 33 is shown located at the junction between the top surface and the groove. A chamfer or fillet may form any shape or profile as desired to provide a void or reduced profile to improve demolding performance.

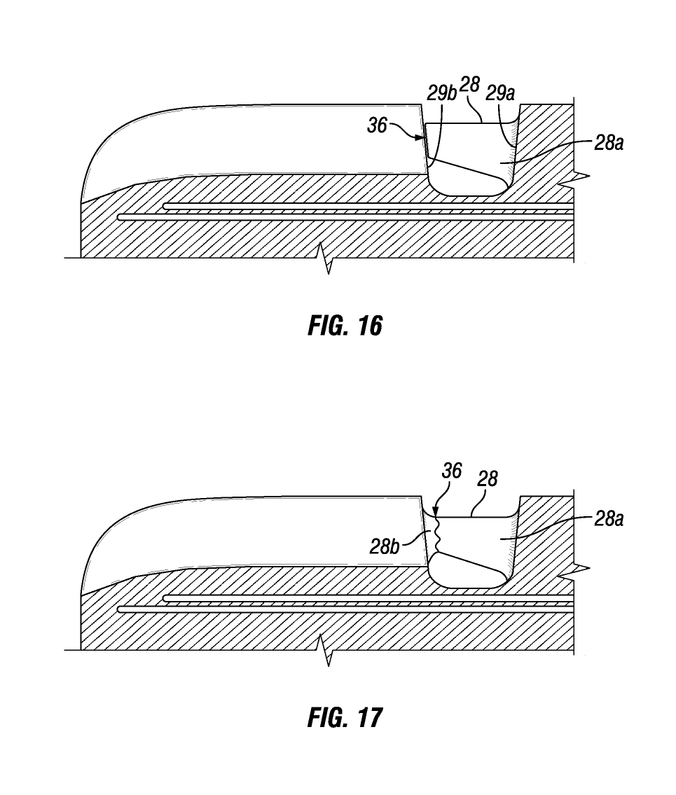

It is appreciated that in any embodiment discussed previously or hereafter, a split bridge formed of a pair of projections may be substituted with a split bridge formed of a single projection extending the substantial length of the split bridge. In doing so, the narrow gap is moved to a location adjacent to one of the pair of opposing groove sides, or, in other words, between a terminal end of the single projection and one of the pair opposing sides. For example, with reference to an exemplary embodiment shown in FIG. 16, the split bridge 28 forms a single projection 28a extending the substantial length of the split bridge, where the narrow gap 36 is arranged between a terminal end of the single projection and the other side 29b of the pair of opposing sides of the groove 26. As such, the second projection from the exemplary embodiments of FIGS. 13 to 15 has been eliminated, making demolding even easier.

It is appreciated that in any embodiment discussed previously or hereafter, the end surface of the terminal end of any projection partially includes or fully comprises a non-planar, undulating surface and a surface arranged on the opposite side of the gap facing the terminal end of the projection that partially includes or fully comprises a non-planar, undulating surface. In certain embodiments, any such non-planar, undulating surface may comprise a surface texture. This assists to limit lateral or radial movement of a tread block relative to its neighboring tread block when the tread block is in the contact patch. For example, with reference to an exemplary embodiment shown in FIG. 17, the terminal end of each of a pair of projections 28a, 28b, which together form a bridge 28, the opposing terminal ends form non-linear, undulating surfaces. It is appreciated that these non-linear, undulating surfaces may comprise any desired form and any arrangement discussed elsewhere herein.

While the split bridges described above in FIGS. 13-17 were arranged in a longitudinal groove, each may also be employed in lateral grooves as desired.

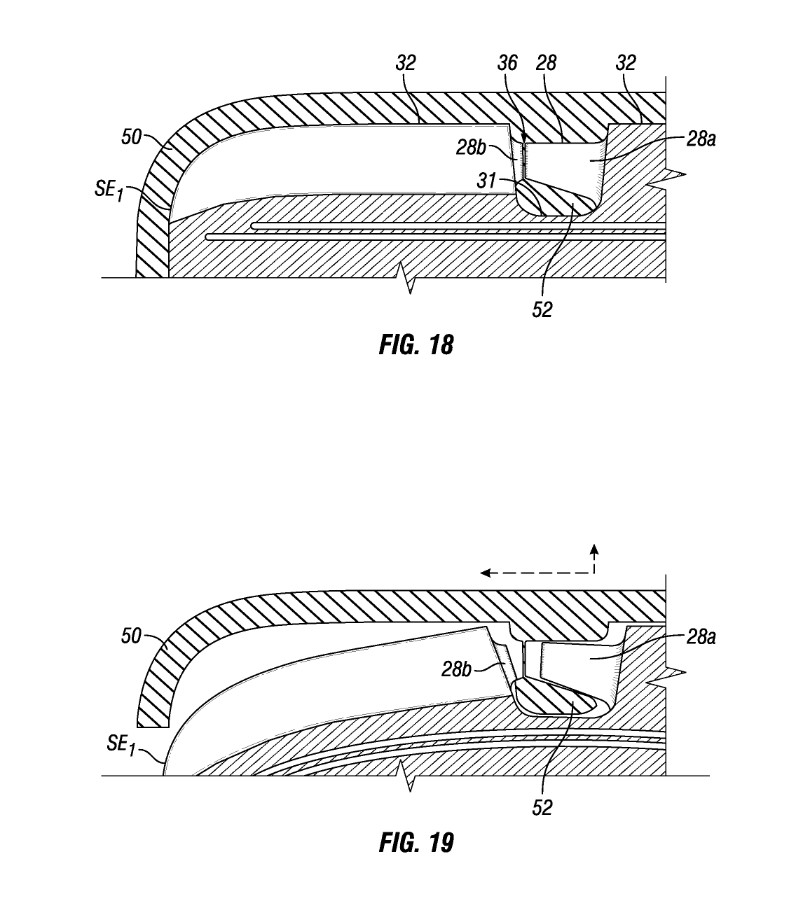

To show better how demolding is improved when using an improved split bridge in a longitudinal groove, reference is made to FIGS. 18 and 19. In FIG. 18, in a method for demolding a tire tread, a mold 50 is provided having a molding cavity configured to mold a tire tread. It is appreciated that this mold may be a mold designed to only mold a tire tread or to mold both a tire tread with a tire. The tire tread shown in the mold is the tire tread described in association with FIG. 14, but may comprise a tire tread having any split bridge described herein arranged in a longitudinal groove. The mold depicted includes a molding member 52 arranged between the split bridge 28 and the bottom surface 31 of the groove for use in forming the split bridge and the void arranged thereunder. After molding polymeric material inserted into the molding cavity to form a molded tread, demolding of the tread occurs, with or without any tire molded therewith. With reference to FIG. 19, in demolding the molded tread from the mold 50, the molding member 52 is pulled through the split bridge by deforming projection 28a as the molding member passes through the narrow gap 36. By providing a short second projection 28b, or by eliminating the second projection in other embodiments, the second projection (and therefore the split bridge) does not overly hinder the demolding of the tread (and tire, if present) from the mold. In this exemplary embodiment, the groove, at the location of the split bridge, is located closer to the first side edge SE1 than the second side edge along the tread width, and the other side 29b of the pair of sides of the groove 26 is located closer to the first side edge SE1 of the tread width than the one side 29a of the opposing sides. Also, the molding member 52 translates relative to the tire tread in a substantially lateral direction of the tread (that is, in a direction where the lateral direction is the primary component of relative translation) and towards the first side edge during the step of demolding and to a lesser degree in a direction outward from the tread thickness (e.g., a radial component or a normal component to the outer, ground-engaging side of the tread).

While this invention has been described with reference to particular embodiments thereof, it shall be understood that such description is by way of illustration and not by way of limitation. For example, the present invention could be combined with classical groove bridges or chamfers could be added between the intersections of the top surface of the tread blocks and the lateral surfaces of the lateral grooves. Furthermore, particular dimensions have been given but it is well within the purview of one skilled in the art to make adjustments to these dimensions and still practice the spirit of the present invention. Accordingly, the scope and content of the invention are to be defined only by the terms of the appended claims.

What is claimed is:

1. A tread for a tire having laterally and circumferentially extending grooves that define tread blocks, the tread comprising:
one or more split bridges extending within one groove of said grooves and extending from one of a pair of opposing sides defining a groove width of the one groove, each of the one or more split bridges having a length spanning the groove width except for a narrow gap arranged between the opposing sides defining the groove width, the length being formed by one or more projections extending from one of the opposing sides of the one groove and towards the other of the opposing sides, where one projection of the one or more projections extends from one side of the opposing sides of the one groove, where each of the one or more split bridges is spaced a predetermined distance from a bottom surface of the groove to provide a void between the split bridge and the bottom surface.

2. The tread of claim 1, where the one projection has a length extending more than 50% of the split bridge length, such that the narrow gap is spaced apart from a midpoint of the split bridge length.

3. The tread of claim 1, where each of the one or more split bridges is spaced a predetermined distance from a top surface of the tread.

4. The tire tread of claim 1, where the at least one projection comprises a single projection, the one projection forming the single projection and extending the substantial length of the split-bridge, and where the narrow gap is arranged between a terminal end of the single projection and the other of the pair of opposing sides of the one groove.

5. The tire tread of claim 1, where the at least one projection comprises a pair of projections forming of the one projection and a second projection, the second projection extending from the other side of the pair of opposing sides of the one groove opposite the one projection, where the narrow gap is arranged between terminal ends of the pair of projections.

6. The tire tread of claim 1, where the one projection extends from the groove bottom surface and from the one of the pair of opposing sides of the one groove such that the width of the one groove below the one or more projections is narrowed.

7. The tire tread of claim 1, where the one groove is a longitudinal groove.

8. The tire tread of claim 7, where the narrow gap is spaced apart from the midpoint of the length of the split bridge closest to the other side of the pair of opposing sides of the one groove, where the tread has a width extending between a first side edge and a second side edge, where the one groove, at the location of the split bridge, is located closer to the first side edge than the second side edge along the tread width, and where the other side of the pair of sides of the one groove is located closer to the first side edge of the tread width than the one side of the opposing sides.

9. The tread of claim 8, where the one or more split bridges form a plurality of split bridges arranged in one or more longitudinal grooves.

10. The tread of claim 1, wherein in the narrow gap is about 0.5 mm or less.

11. The tread of claim 1, wherein the end surface of the terminal end of the projection has a non-planar, undulating surface and a surface arranged on the opposite side of the gap facing the terminal end of the projection is a non-planar, undulating surface.

12. The tread of claim 1 wherein the one projection length extends at least 67% of the length of the split bridge.

13. The tire tread of claim 1, where at a junction between the tread top surface and the groove at one or both of each opposing sides of the groove, a chamfer or fillet is arranged between the top surface and the groove.

14. The tread of claim 1, which further comprises a tire having a carcass and a summit belt package having a top belt and a bottom belt to which said tread is attached.

15. A method of demolding a tire tread, the method comprising:
providing a mold having a molding cavity configured to mold a tire tread having laterally and circumferentially extending grooves that define tread blocks and one or more split bridges extending within one groove of said grooves and extending from one of a pair of opposing sides defining a groove width of the one groove, each of the one or more split bridges having a length spanning the groove width except for a narrow gap arranged between the opposing sides defining the groove width, the length being formed by one or more projections extending from one of the opposing sides of the one groove and towards the other of the opposing sides, where one projection of the one or more projections extends from one side of the opposing sides of the one groove, where each of the one or more split bridges is spaced a predetermined distance from a bottom surface of the groove to provide a void between the split bridge and the bottom surface;
molding polymeric material inserted into the molding cavity to form a molded tread;
demolding the molded tread from the mold, where a molding member for forming the split bridge of the one or more split bridges arranged between the split bridge and the bottom surface of the one groove during the step of molding is pulled through the split bridge by deforming the one projection.

16. The method of claim 15, where the one projection has a length extending more than 50% of the split bridge length, such that the narrow gap is spaced apart from a midpoint of the split bridge length.

17. The method of claim 15, where the one groove is a longitudinal groove, where the tread has a width extending between a first side edge and a second side edge, where the one groove, at the location of the split bridge, is located closer to the first side edge than the second side edge along the tread width, and where the other side of the pair of sides of the one groove is located closer to the first side edge of the tread width than the one side of the opposing sides, and where the molding member translates at least partially in a lateral direction towards the first side edge during the step of demolding.
